(19) United States
(12) Patent Application Publication
(10) Pub. No.: US 2013/0198688 A1
(43) Pub. Date: Aug. 1, 2013

(54) ELECTRONIC DEVICE, STORAGE MEDIUM AND METHOD FOR SEARCHING MENU OPTIONS OF THE ELECTRONIC DEVICE

(71) Applicant: CHI LIU-HSU, Tu-Cheng (TW)

(72) Inventor: CHI LIU-HSU, Tu-Cheng (TW)

(73) Assignee: CHI MEI COMMUNICATION SYSTEMS, INC., Tu-Cheng (TW)

(21) Appl. No.: 13/533,990

(22) Filed: Jun. 27, 2012

(30) Foreign Application Priority Data
Jan. 31, 2012 (TW) 101103155

(51) Int. Cl. G06F 3/048

(52) U.S. Cl. 715/816

(57) ABSTRACT

In a method of an electronic device for searching menu options of the electronic device, the menu options of the electronic device are listed in order in a menu list that is stored in a storage system of the electronic device. The menu list is displayed on a display screen of the electronic device. A keyword input by a user using a search bar of the menu list is acquired. The menu list is searched for menu options that match the input keyword. The display of the menu options that match the input keyword is retained in the menu list on the display screen, and the display of menu options that do not match the input keyword is hidden in the menu list on the display screen.

### BACKGROUND

1. Technical Field

Embodiments of the present disclosure relate to data processing devices and methods, and more particularly to an electronic device, a storage medium, and a method for searching menu options of the electronic device.

2. Description of Related Art

Menus in an electronic device, such as a mobile phone or a personal digital assistant, are usually organized using a hierarchical structure. A menu of the electronic device may include several sub-menus, and each of the sub-menus may further include several sub-menus or menu options related to functions of the electronic device. If a user wants to find a specific menu option, but the user is not familiar with the structure of the menus, the user may have to search many different levels of the menus for the specific menu option.

### BRIEF DESCRIPTION OF THE DRAWINGS

FIG. 1 is a block diagram of one embodiment of an electronic device including a menu options search system.

FIG. 2 is a flowchart of one embodiment of a method for searching menu options of the electronic device of FIG. 1.

FIGS. 3A-3B are schematic diagrams illustrating searching for the menu options according to a keyword input by a user.

FIGS. 4A-4B are schematic diagrams of illustrating searching for the menu options according to a category icon selected by the user.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

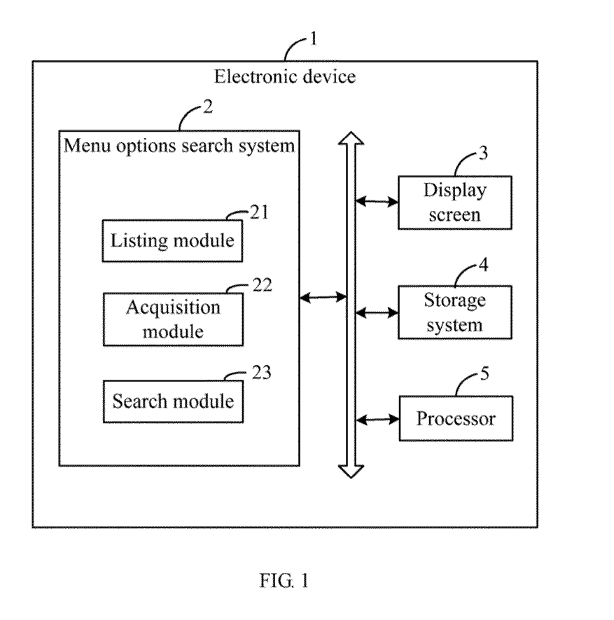

FIG. 1 is a block diagram of one embodiment of an electronic device 1 including a menu options search system 2. In the embodiment, the electronic device 1 further includes a display screen 3, a storage system 4, and at least one processor 5. The storage system 4 stores a plurality of menu options that are respectively related to functions of the electronic device 1. For example, the menu options may include a “BLUETOOTH” menu option, a “volume” menu option, or an “airplane mode” menu option. The electronic device 1 may be, for example, a mobile phone, a personal digital assistant, a handheld game console, or a tablet computer. The menu options search system 2 may be in form of one or more programs that are stored in the storage system 4 and executed by the at least one processor 5. FIG. 1 is just one example of the electronic device 1 that can be included with more or fewer components than shown in other embodiments, or have a different configuration of the various components.

The display screen 3 may be a touch-sensitive display screen or a normal display screen that can display the menu options to users. In one embodiment, the storage system 4 may be random access memory for temporary storage of information, and/or a read only memory for permanent storage of information. In other embodiments, the storage system 4 may also be an external storage device, such as a storage card or a data storage medium. The at least one processor 5 executes computerized operations of the electronic device 1 and other applications, to provide functions of the electronic device 1.

The menu options search system 2 organizes the menu options stored in the storage system 4 using a non-hierarchical structure, and searches the menu options according to user requirements. In the embodiment, the menu options search system 2 may include a listing module 21, an acquisition module 22, and a search module 23. The modules 21-23 may comprise a plurality of functional modules each comprising one or more programs or computerized codes that are stored in the storage system 4, and can be accessed and executed by the at least one processor 5. A detailed description of the functions of the modules 21-23 is given as follows.

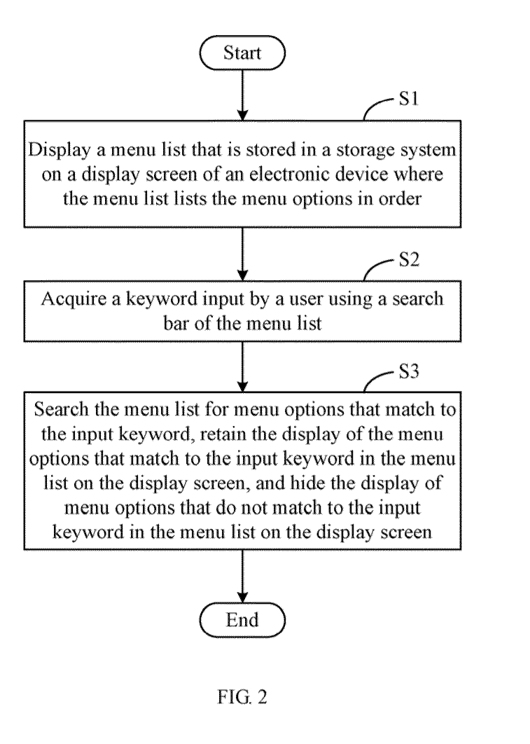

FIG. 2 is a flowchart of one embodiment of a method for searching menu options of the electronic device 1 of FIG. 1. Depending on the embodiment, additional steps may be added, others removed, and the ordering of the steps may be changed.

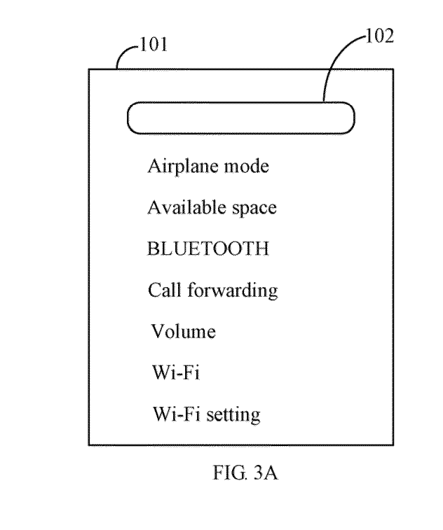

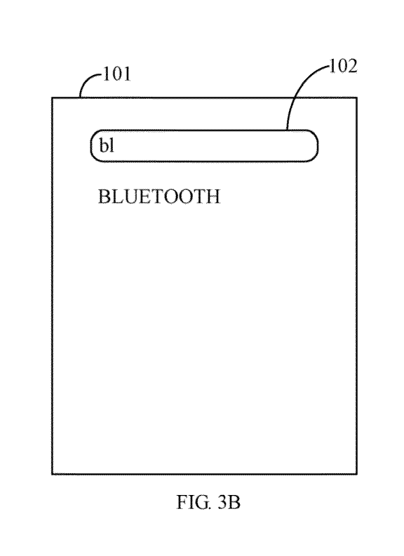

In step S1, the listing module 21 displays a menu list that is stored in the storage system 4 on the display screen 3 where the menu list lists the menu options in order. For example, the menu options may be listed in the menu list in alphabetical order. In the embodiment, the menu list further includes a search bar. The user can input a keyword in the search bar in order to search for a specific menu option. For example, FIG. 3A shows a menu list 101 that includes the search bar 102 and seven menu options listed in alphabetical order, wherein the seven menu options are “Airplane mode”, “Available space”, “BLUETOOTH”, “Call forwarding”, “Volume”, “Wi-Fi”, and “Wi-Fi setting.”

In step S2, the acquisition module 22 acquires a keyword input by the user using the search bar 102. In one embodiment, the keyword can be defined as a character string of a name of the specific menu option. For example, the user may input a keyword “b1” to the search bar 102 as shown in FIG. 3B. In another embodiment, each of the menu options in the storage system 4 has a function description, thus the keyword also can be defined as a character string of a function description of the specific menu option. For example, a function description of the “Volume” menu option may be “Adjusting volume of the electronic device.”

In step S3, the search module 23 searches the menu list 101 for menu options that match the input keyword, retains the display of the menu options that match the input keyword in the menu list 101 on the display screen 3, and hides the display of menu options that do not match the input keyword in the menu list 101 on the display screen 3. The search module 23 can compare each character of the keyword and each character of the names of menu options in the menu list 101 one by one. For example, if the input keyword is “b1” as shown in FIG. 3B, the search module 23 searches for the “BLUETOOTH” menu option whose name has a first character “b” and a second character “1.” If one of the menu options matches to the input keyword “b1,” the search module 23 retains the display of the menu option (e.g., “BLUETOOTH” menu option) in the menu list 101 on the display screen 3, and hides the display of the other menu options in the menu list 101 on the display screen 3 as shown in FIG. 3.

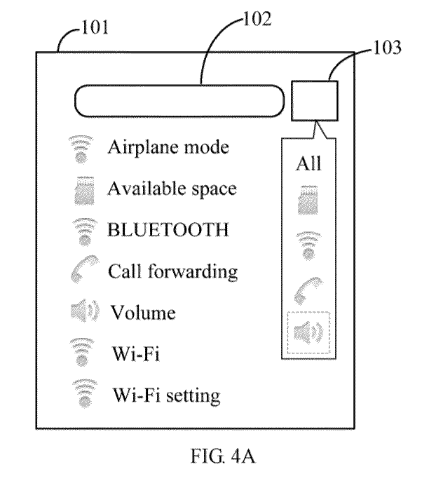

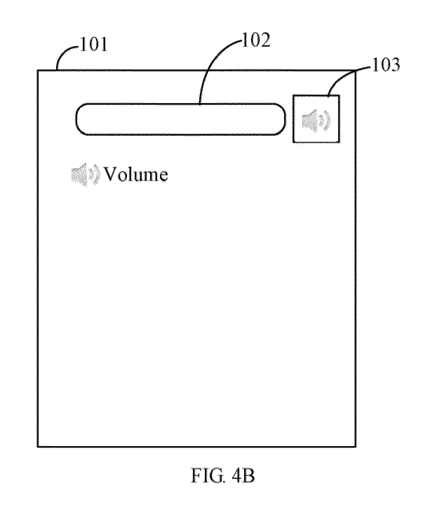

In another embodiment, each of the menu options in the menu list 101 has a category icon that indicates a category of function of the menu option. For example, the “Airplane mode” menu option is related to a network function, so the category of function of the “Airplane mode” menu option is related to the network function as shown in FIG. 4A. In this case, the menu list 101 further includes a filter bar 103 as shown in FIG. 4A. The user can select a category icon from the filter bar 103, and the acquisition module 22 acquires the selected category icon from the filter bar 103. The search module 23 searches the menu list 101 for menu options that have the selected category icon, retains the display of the menu options that have the selected category icon in the menu list 101 on the display screen 3, and hides the display of menu options that do not have the selected category icon in the menu list 101 on the display screen 3.

Referring to FIG. 3A, the filter bar 103 lists several category icons for selection of the user, wherein a category icon in a dotted line box is the selected category icon. The search module 23 searches for the “Volume” menu option that has the selected category icon, and only displays the “Volume” menu option in the menu list 101 on the display screen 3 as shown in FIG. 4B.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system that stores a plurality of menu options;
at least one processor;
one or more programs stored in the storage system and executed by the at least one processor, the one or more programs comprising:
a listing module that displays a menu list listing the menu options in order on a display screen of the electronic device;
an acquisition module that acquires a keyword input by a user using a search bar of the menu list;
a search module that searches the menu list for menu options that match the input keyword, retains the display of the menu options that match the input keyword in the menu list on the display screen, and hides the display of menu options that do not match the input keyword in the menu list on the display screen.

2. The electronic device of claim 1, wherein the keyword is defined as a character string of a name of a menu option specified by the user.

3. The electronic device of claim 1, wherein the keyword is defined as a character string of a function description of the menu option specified by the user.

4. The electronic device of claim 1, wherein each of the menu options in the menu list has a category icon that indicates a category of function of the menu option.

5. The electronic device of claim 4, wherein the acquisition module further acquires a category icon selected by the user using a filter bar of the menu list.

6. The electronic device of claim 5, wherein the search module further searches the menu list for menu options that have the selected category icon, retains the display of the menu options that have the selected category icon in the menu list on the display screen, and hides the display of menu options that do not have the selected category icon in the menu list on the display screen.

7. A method of an electronic device for searching menu options of the electronic device, the method comprising:
displaying a menu list listing the menu options in order on a display screen of the electronic device;
acquiring a keyword input by a user using a search bar of the menu list;
searching the menu list for menu options that match the input keyword;
retaining the display of the menu options that match the input keyword in the menu list on the display screen; and
hiding the display of menu options that do not match the input keyword in the menu list on the display screen.

8. The method of claim 7, wherein the keyword is defined as a character string of a name of a menu option specified by the user.

9. The method of claim 7, wherein the keyword is defined as a character string of a function description of the menu option specified by the user.

10. The method of claim 7, wherein each of the menu options in the menu list has a category icon that indicates a category of function of the menu option.

11. The method of claim 10, further comprising:
acquiring a category icon selected by the user using a filter bar of the menu list.

12. The method of claim 11, further comprising:
searching the menu list for menu options that have the selected category icon;
retaining the display of the menu options that have the selected category icon in the menu list on the display screen; and
hiding the display of menu options that do not have the selected category icon in the menu list on the display screen.

13. A non-transitory storage medium storing a set of instructions, the set of instructions capable of being executed by a processor of an electronic device, causes the processor to execute a method of the electronic device for searching menu options of the electronic device, the method comprising:
displaying a menu list listing the menu options in order on a display screen of the electronic device;
acquiring a keyword input by a user using a search bar of the menu list;
searching the menu list for menu options that match the input keyword;
retaining the display of the menu options that match the input keyword in the menu list on the display screen; and
hiding the display of menu options that do not match the input keyword in the menu list on the display screen.

14. The storage medium of claim 13, wherein the keyword is defined as a character string of a name of a menu option specified by the user.

15. The storage medium of claim 13, wherein the keyword is defined as a character string of a function description of the menu option specified by the user.

16. The storage medium of claim 13, wherein each of the menu options in the menu list has a category icon that indicates a category of function of the menu option.

17. The storage medium of claim 16, wherein the method further comprises:
acquiring a category icon selected by the user using a filter bar of the menu list.

18. The storage medium of claim 17, wherein the method further comprises:
searching the menu list for menu options that have the selected category icon;
retaining the display of the menu options that have the selected category icon in the menu list on the display screen; and
hiding the display of menu options that do not have the selected category icon in the menu list on the display screen.
